(19) United States
(12) Patent Application Publication
(10) Pub. No.: US 2024/0378419 A1
(43) Pub. Date: Nov. 14, 2024

(54) APPARATUS FOR ESTIMATING UNCERTAINTY OF AN ARTIFICIAL NEURAL NETWORK MODEL AND A METHOD THEREOF

(71) Applicants: HYUNDAI MOTOR COMPANY, Seoul (KR); KIA CORPORATION, Seoul (KR)

(72) Inventors: Hack Jin Lee, Gwangju-si (KR); Byeong Wook Jeon, Seoul (KR)

(73) Assignees: HYUNDAI MOTOR COMPANY, Seoul (KR); KIA CORPORATION, Seoul (KR)

(21) Appl. No.: 18/243,514

(22) Filed: Sep. 7, 2023

(30) Foreign Application Priority Data
May 11, 2023 (KR) 10-2023-0061194

(51) Int. Cl. G06N 3/045

(52) U.S. Cl. CPC G06N 3/045

(57) ABSTRACT

An apparatus for estimating uncertainty of an artificial neural network model and a method thereof are disclosed. The apparatus includes storage that stores a clustering model having a plurality of clusters. The apparatus also includes a controller that extracts a feature pattern from a hidden layer of the artificial neural network model, determines a cluster corresponding to the feature pattern by using the clustering model, and estimates uncertainty of the artificial neural network model based on a relationship with the cluster.

### CROSS-REFERENCE TO RELATED APPLICATION

This application claims the benefit of priority to Korean Patent Application No. 10-2023-0061194, filed in the Korean Intellectual Property Office on May 11, 2023, the entire contents of which are incorporated herein by reference.

### TECHNICAL FIELD

The present disclosure relates to a technique for estimating uncertainty for inference of an artificial neural network model.

### BACKGROUND

In general, an artificial neural network (ANN), which is a field of artificial intelligence, is an algorithm for allowing a machine to learn made by simulating a human neural structure. Recently, the artificial neural network has been applied to image recognition, speech recognition, natural language processing, and the like and has shown excellent effects. An artificial neural network includes an input layer that receives an input, a hidden layer that actually learns, and an output layer that returns the result of an operation. The artificial neural network including the plurality of hidden layers is called a deep neural network (DNN), which is also a kind of artificial neural network.

An artificial neural network allows a computer to learn by itself based on data. When trying to solve a problem using an artificial neural network, it is necessary to prepare a suitable artificial neural network model and data to be analyzed. An artificial neural network model to solve a problem is trained based on data. Before training the model, it is necessary to properly process the data first. This is because the input data and output data required by the artificial neural network model are standardized. Therefore, a process of preprocessing the acquired raw data to suit the requested input data is required. After the preprocessing is completed, the processed data is required to be divided into two types. In other words, the data should be divided into a train dataset and a validation dataset. The train dataset is used to train the model, and the validation dataset is used to verify the performance of the model.

There are various reasons for validating an artificial neural network model. An artificial neural network developer tunes the model by modifying the hyper parameters of a model based on the verification result of the model. In addition, the model verification is performed to select a suitable model from various models. The reasons why the model verification is necessary are explained in more detail as follows.

The first reason is to predict accuracy. As a result, the purpose of artificial neural networks is to achieve good performance on out-of-sample data not used for training. Therefore, after creating the model, it is essential to check how well the model will perform on out-of-sample data. However, because the model should not be verified using the train dataset, the accuracy of the model should be measured using the validation dataset separated from the train dataset.

The second reason is to increase the performance of the model by tuning the model. For example, it is possible to prevent overfitting. Overfitting means that the model is over-trained on the train dataset. For example, when the training accuracy is high but the validation accuracy is low, the occurrence of overfitting may be suspected. In addition, it may be understood in more detail through training loss and validation loss. When overfitting occurs, it is necessary to prevent overfitting to increase the validation accuracy. It is possible to prevent overfitting by using a scheme such as regularization or dropout.

In order to estimate the uncertainty of an artificial neural network model, a Bayesian network-based uncertainty estimation scheme, a Monte-Carlo dropout-based uncertainty estimation scheme, and the like are generally used. Because such schemes require high computational complexity and space complexity (e.g., a large amount of memory resources), there is a limit to their application to an embedded environment, and in particular, an additional library is required.

The matters described in this background section are intended to promote an understanding of the background of the disclosure and may include matters that are not already known to those of ordinary skill in the art.

### SUMMARY

The present disclosure has been made to solve the above-mentioned problems occurring in the prior art while advantages achieved by the prior art are maintained intact.

In an embodiment, an apparatus for estimating uncertainty of an artificial neural network model includes a clustering model having a preset number of clusters for a plurality of feature patterns. The apparatus may extract an output of a hidden layer in the artificial neural network model as a feature pattern. The apparatus may also determine a cluster corresponding to the feature pattern by using the clustering model. The apparatus may also estimate the uncertainty of the artificial neural network model based on a relationship with the cluster. Thus, it is possible to significantly reduce the time complexity and space complexity required for estimating the uncertainty of the artificial neural network model and improve the accuracy of estimation. The present disclosure also provides a method thereof.

In another embodiment, an apparatus for estimating uncertainty of an artificial neural network model includes a clustering model having a preset number of clusters for a plurality of feature patterns. The apparatus may extract an output of a hidden layer in the artificial neural network model as a feature pattern. The apparatus may also determine a cluster corresponding to the feature pattern by using the clustering model. The apparatus may also estimate an uncertainty value preset for the cluster as an uncertainty value of the feature pattern. Thus, it is possible to significantly reduce the time complexity and space complexity required for estimating the uncertainty of the artificial neural network model and improve the accuracy of estimation. The present disclosure also provides a method thereof.

In another embodiment, an apparatus for estimating uncertainty of an artificial neural network model includes a clustering model having a preset number of clusters for a plurality of feature patterns. The apparatus may extract an output of a hidden layer in the artificial neural network model as a feature pattern. The apparatus may also determine a cluster corresponding to the feature pattern by using the clustering model. The apparatus may also estimate a distance between the representative pattern in the cluster and the feature pattern as an uncertainty value of the feature pattern. Thus, it is possible to significantly reduce the time complexity and space complexity required for estimating the uncertainty of the artificial neural network model and improve the accuracy of estimation. The present disclosure also provides a method thereof.

The technical problems to be solved by the present disclosure are not limited to the aforementioned problems. Any other technical problems not mentioned herein should be clearly understood from the following description by those having ordinary skill in the art to which the present disclosure pertains. Also, it may be easily understood that the objects and advantages of the present disclosure may be realized by the units and combinations thereof recited in the claims.

In an embodiment, an apparatus for estimating uncertainty of an artificial neural network model includes storage that stores a clustering model having a plurality of clusters. The apparatus also includes a controller that extracts a feature pattern from a hidden layer of the artificial neural network model. The controller also determines a cluster corresponding to the feature pattern by using the clustering model. The controller also estimates uncertainty of the artificial neural network model based on a relationship with the cluster.

In an embodiment, the controller may normalize the feature pattern.

In an embodiment, the clustering model may include a plurality of representative patterns for each section as a clustering model of a section division structure.

In an embodiment, the controller may divide the feature pattern into a plurality of sections. The controller may also compare a first section of the feature pattern with representative patterns in a first section of the clustering model to determine a first representative pattern that is most similar. The controller may also compare a second section of the feature pattern with representative patterns in a second section of the clustering model to determine a second representative pattern that is most similar. The controller may also determine a cluster corresponding to an integrated representative pattern formed of sequential combinations of the first representative pattern and the second representative pattern as a cluster of the feature pattern.

In an embodiment, the controller may determine a representative pattern that is most similar to the feature pattern for each of the divided sections.

In an embodiment, the controller may select a representative pattern having a shortest dot product or Euclidean distance, least mean square (LMS), or cross correlation (CC) with respect to the feature pattern for each divided section.

In an embodiment, the storage may further store a table in which uncertainty values for each of the plurality of clusters are recorded.

In an embodiment, the controller is configured to determine an uncertainty value corresponding to the cluster based on the table.

In an embodiment, the controller may determine a distance between an integrated representative pattern of the cluster and the feature pattern as an uncertainty value of the feature pattern.

In an embodiment, the controller may determine the feature pattern as an out of distribution (OOD) pattern when a distance between the integrated representative pattern of the cluster and the feature pattern exceeds a threshold distance.

In an embodiment, the clustering model may include a plurality of representative patterns for each layer as a tree-structured clustering model.

In an embodiment, the controller is configured to determine a first representative pattern that is most similar to the feature pattern among representative patterns of a first layer in the tree-structured clustering model. The controller is also configured to determine a second representative pattern that is most similar to the feature pattern among sub-representative patterns of the first representative pattern. The controller is also configured to determine a cluster corresponding to the second representative pattern as a cluster of the feature pattern.

In an embodiment, the controller may determine a representative pattern that is most similar to the feature pattern for each layer.

In an embodiment, the controller may select a representative pattern having a shortest dot product or Euclidean distance, least mean square (LMS), or cross correlation (CC) with respect to the feature pattern for each layer.

In an embodiment, the controller may determine a distance between the second representative pattern of the cluster and the feature pattern as an uncertainty value of the feature pattern.

In an embodiment, the controller may determine the feature pattern as an out of distribution (OOD) pattern when a distance between the second representative pattern of the cluster and the feature pattern exceeds a threshold distance.

In another embodiment, a method of estimating uncertainty of an artificial neural network model includes storing, by storage, a clustering model having a plurality of clusters. The method also includes extracting, by a controller, a feature pattern from a hidden layer of the artificial neural network model. The method also includes determining, by the controller, a cluster corresponding to the feature pattern by using the clustering model. The method also includes estimating, by the controller, uncertainty of the artificial neural network model based on a relationship with the cluster.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating an apparatus for estimating uncertainty of an artificial neural network model according to an embodiment of the present disclosure;

FIG. 2 is a diagram illustrating characteristics of a clustering model provided in an apparatus for estimating uncertainty of an artificial neural network model according to an embodiment of the present disclosure;

FIG. 3 is a diagram illustrating uncertainty values for each cluster provided in an apparatus for estimating uncertainty of an artificial neural network model according to an embodiment of the present disclosure;

FIG. 4 is a diagram illustrating a first example of a process of determining a cluster corresponding to a feature pattern by a controller provided in an apparatus for estimating uncertainty of an artificial neural network model according to an embodiment of the present disclosure;

FIG. 5 is a diagram illustrating a process of determining a plurality of representative patterns within each section by a controller provided in an apparatus for estimating uncertainty of an artificial neural network model according to an embodiment of the present disclosure;

FIG. 6 is a diagram illustrating a second example of a process of determining a cluster corresponding to a feature pattern by a controller provided in an apparatus for estimating uncertainty of an artificial neural network model according to an embodiment of the present disclosure;

FIG. 7 is a diagram illustrating a process of determining an uncertainty value of a feature pattern by a controller provided in an apparatus for estimating uncertainty of an artificial neural network model according to an embodiment of the present disclosure;

FIG. 8 is a flowchart illustrating a method of estimating uncertainty of an artificial neural network model according to an embodiment of the present disclosure; and

FIG. 9 is a block diagram illustrating a computing system for executing a method of estimating uncertainty of an artificial neural network model according to an embodiment of the present disclosure.

### DETAILED DESCRIPTION

Hereinafter, some embodiments of the present disclosure are described in detail with reference to the drawings. In adding the reference numerals to the components of each drawing, it should be noted that the identical or equivalent components are designated by the identical numeral even when the components are displayed on other drawings. Further, in describing the embodiment of the present disclosure, a detailed description of the related known configuration or function has been omitted when it is determined that the detailed description interferes with the understanding of the embodiment of the present disclosure. When a component, device, element, or the like of the present disclosure is described as having a purpose or performing an operation, function, or the like, the component, device, element, or the like should be considered herein as being “configured to” meet that purpose or to perform that operation or function. Each of the component, device, element, and the like may separately embody or be included with a processor and a memory, such as a non-transitory computer readable media, as part of the apparatus.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It should be further understood that terms, such as those defined in commonly used dictionaries, should be interpreted as having a meaning that is consistent with their meaning in the context of the relevant art and should not be interpreted in an idealized or overly formal sense unless expressly so defined herein.

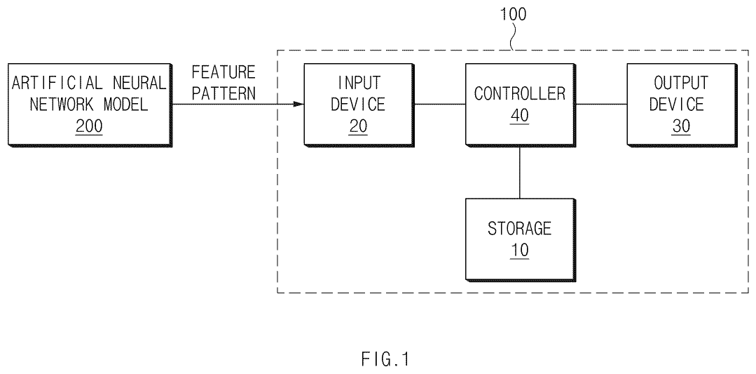

FIG. 1 is a block diagram illustrating an apparatus for estimating uncertainty of an artificial neural network model according to an embodiment of the present disclosure.

As shown in FIG. 1, an apparatus 100 for estimating uncertainty of an artificial neural network model according to an embodiment of the present disclosure may include storage 10, an input device 20, an output device 30, and a controller 40. In this case, depending on a scheme of implementing the apparatus 100 for estimating uncertainty of an artificial neural network model according to an embodiment of the present disclosure, components may be combined with each other to be implemented as one, or some components may be omitted.

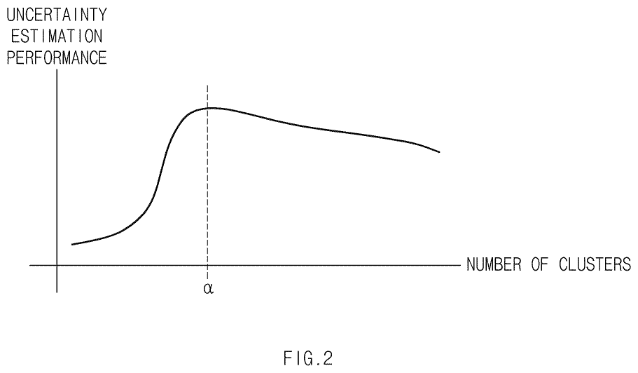

Regarding each component, first, the storage 10 may store a clustering model having the preset number ‘n’ of clusters for a plurality of feature patterns. Such a clustering model may be implemented as, for example, a deep learning model, and the clustering model may perform learning to classify feature patterns included in a plurality of learning datasets into ‘n’ clusters. When a feature pattern is input, the learned clustering model may determine which cluster the feature pattern is to be included in. In this case, the performance of the clustering model may be determined by the uncertainty estimation performance and the number of clusters. In this case, as shown in FIG. 2, a relationship may be established between the uncertainty estimation performance and the number of clusters.

FIG. 2 is a diagram illustrating characteristics of a clustering model provided in an apparatus for estimating uncertainty of an artificial neural network model according to an embodiment of the present disclosure.

As shown in FIG. 2, the vertical axis represents uncertainty estimation performance, and the horizontal axis represents the number of clusters. Initially, as the number of clusters increases, the uncertainty estimation performance also curves upward, but this trend is not maintained indefinitely. In other words, the uncertainty estimation performance peaks at the time point when the number of clusters becomes ‘a’, and then a gentle downward curve begins. Therefore, the number of clusters to be generated by the clustering model may be set to ‘a’. For reference, when the number of clusters is ‘a’ or less, feature patterns of different properties may be classified into the same cluster. When the number of clusters exceeds ‘a’, a fragmentation phenomenon may occur in which the number of clusters is large but the number of samples belonging to each cluster is small, thereby deteriorating the reliability and performance of uncertainty estimation.

In this case, in the scheme of determining ‘a’, for example, a plurality of clustering models having different numbers of clusters are generated, and the performance of the clustering models is individually evaluated to select a clustering model having the best performance. Thereafter, the number of clusters generated in the clustering model having the best performance may be determined as ‘a’. In this case, various schemes such as the following Table 1 may be used to evaluate the performance of each clustering model.

TABLE 1

| | Classification | | |
|---|---|---|---|
| Setting | of problems | Description | Max |
| R-squared | Return | Proportion of variance using | 1 |
| | | least squares scheme that is | |
| | | explained as independent | |
| | | variable (i.e., explanatory | |
| | | power of linear model) | |
| Mean | Return | Average of the absolute | 0 |
| Absolute | | difference between the output | |
| Error | | and the correct answer | |
| (MAE) | | | |
| Accuracy | Classification | =(number of true positives + | 1 |
| | | number of true negatives)/ | |
| | | total number of cases | |
| F1 score | Classification | =(2 × precision × sensitivity)/ | 1 |
| | | (precision + sensitivity) | |

The storage 10 may store various logic, algorithms, and programs required in the process of extracting a feature pattern from a hidden layer of the artificial neural network model. The logic, algorithms, and programs are also required in the process of determining a cluster corresponding to the feature pattern by using the clustering model. The logic, algorithms, and programs are also required in the process of estimating uncertainty of the artificial neural network model based on a relationship with the cluster.

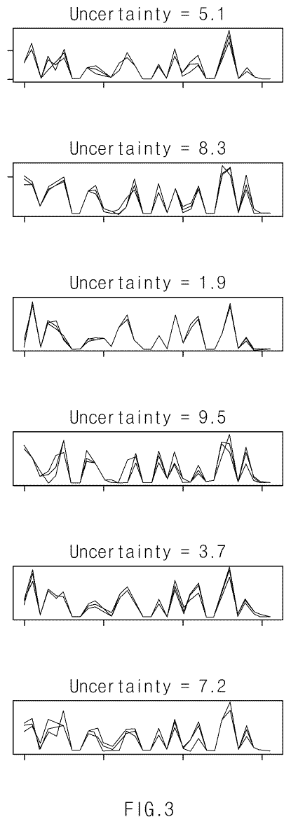

The storage 10 may store various logic, algorithms, and programs required in the process of extracting an output of a hidden layer in an artificial neural network model as a feature pattern. The logic, algorithms, and programs are also required in the process of determining a cluster corresponding to the feature pattern by using the clustering model. The logic, algorithms, and programs are also required in the process of estimating an uncertainty value preset for the cluster as an uncertainty value of the feature pattern. In this case, the preset uncertainty value for each cluster is as shown in FIG. 3 as an example.

FIG. 3 is a diagram illustrating uncertainty values for each cluster stored in storage provided in an apparatus for estimating uncertainty of an artificial neural network model according to an embodiment of the present disclosure. Although six clusters are described as an example, it is desirable that the number of clusters is determined as ‘α.’

As shown in FIG. 3, a first cluster has 5.1 set as the uncertainty value, a second cluster has 8.3 set as the uncertainty value, a third cluster has 1.9 set as the uncertainty value, a fourth cluster has 9.5 set as the uncertainty value, a fifth cluster has 3.7 set as the uncertainty value, and a sixth cluster has 7.2 set as the uncertainty value. A table in which uncertainty values for each cluster are recorded may be stored in the storage 10.

The storage 10 may store various logic, algorithms, and programs required in the process of extracting an output of a hidden layer in an artificial neural network model as a feature pattern. The logic, algorithms, and programs are also required in the process of determining a cluster corresponding to the feature pattern by using the clustering model. The logic, algorithms, and programs are also required in the process of estimating a distance between the representative pattern in the cluster and the feature pattern as an uncertainty value of the feature pattern.

The storage 10 may store an inner product calculation algorithm, a Euclidean Norm calculation algorithm, a least mean square (LMS) algorithm, and a cross correlation (CC) algorithm used to calculate the distance between the representative pattern in the cluster and the feature pattern.

The storage 10 may include at least one type of a storage medium of memories of a flash memory type, a hard disk type, a micro type, a card type (e.g., a secure digital (SD) card or an extreme digital (XD) card), a random access memory (RAM), a static RAM, a read-only memory (ROM), a programmable ROM (PROM), an electrically erasable PROM (EEPROM), a magnetic memory (MRAM), a magnetic disk, an optical disk type memory, or the like.

The input device 20 may receive a feature pattern output from a hidden layer of an artificial neural network model. The function of the input device 20 may be performed by the controller 40.

The output device 30 may eventually output the uncertainty value of the artificial neural network model by outputting the uncertainty value of the feature pattern output from the hidden layer in the artificial neural network model.

The controller 40 may perform overall control such that each component performs its function. The controller 40 may be implemented in the form of hardware or software or may be implemented in a combination of hardware and software. In an embodiment, the controller 40 may be implemented as a microprocessor but is not limited thereto.

In particular, the controller 40 may receive a feature pattern output from a hidden layer of an artificial neural network model through the input device 20. The controller 40 may also use a clustering model stored in the storage 10 to determine a cluster corresponding to the feature pattern. The controller 40 may also estimate the uncertainty of the artificial neural network model based on the relationship with the cluster.

The controller 40 may receive the feature pattern output from the hidden layer of an artificial neural network model through the input device 20. The controller 40 may also use the clustering model stored in the storage 10 to determine the cluster corresponding to the feature pattern. The controller 40 may also estimate the uncertainty value preset in the cluster as the uncertainty value of the feature pattern.

The controller 40 may receive the feature pattern output from the hidden layer of the artificial neural network model through the input device 20. The controller 40 may also use the clustering model stored in the storage 10 to determine the cluster corresponding to the feature pattern. The controller 40 may also estimate the distance between the representative pattern in the cluster and the feature pattern as the uncertainty value of the feature pattern. In this case, when the artificial neural network model includes a plurality of hidden layers, the controller 40 may extract a feature pattern from an arbitrary hidden layer.

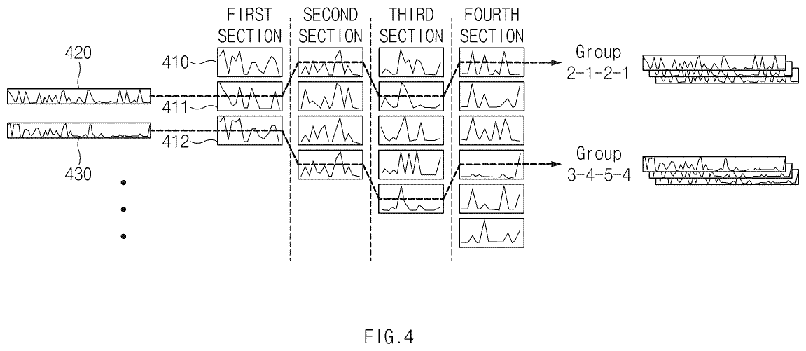

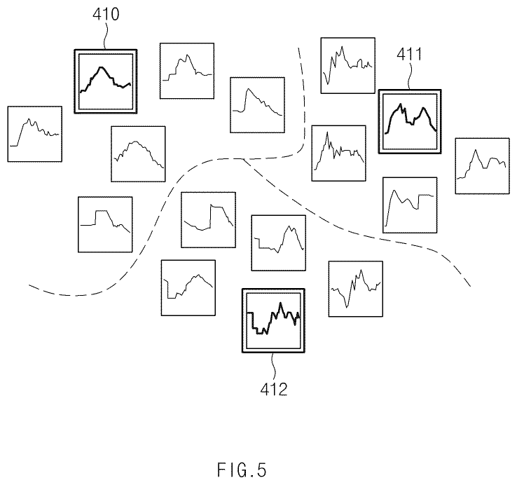

Hereinafter, a process in which the controller 40 determines a cluster corresponding to a feature pattern is described in detail with reference to FIGS. 4 and 5.

FIG. 4 is a diagram illustrating a first example of a process of determining a cluster corresponding to a feature pattern by a controller provided in an apparatus for estimating uncertainty of an artificial neural network model according to an embodiment of the present disclosure.

As shown in FIG. 4, the clustering model of the section division structure according to a first embodiment may have, for example, 4 sections. In this case, the lengths of each section may be the same as or different from each other. For example, when there are three sections, the length of the first section may be 25% of the entire section, the length of the second section may be 25% of the entire section, and the length of the third section may be 50% of the entire section.

As an example, the first section in the clustering model of the section division structure includes 3 representative patterns, the second section includes 4 representative patterns, the third section includes 5 representative patterns, and the fourth section includes 6 representative patterns. Therefore, the number of clusters consisting of the sum of four sections is 360 (=3×4×5×6). In FIG. 4, reference numeral 410 indicates the first representative pattern of the first section, reference numeral 411 indicates the second representative pattern of the first section, and reference numeral 412 indicates the third representative pattern of the first section. In this case, the controller 40 may determine representative patterns of each section based on following Equation 1.

$${J}_{b} ( S ) = \frac{2}{n \vert S \vert} {\sum }_{i ∈ [ n ] , j ∈ S} k ( {k}_{i} , {y}_{j} ) - \frac{1}{{\vert S \vert}^{2}} {\sum }_{i , j ∈ S} k ( {y}_{i} , {x}_{j} ) \qquad [ Equation 1 ]$$

Where J_{b}(S) is an objective function and represents a smaller value when the representative pattern is similar to the feature patterns and the representative patterns are different from each other. In this case, the first term on the right side represents the difference between the feature pattern and the representative pattern, and the second term on the right side represents the difference between the representative patterns.

FIG. 5 is a diagram illustrating a process of determining a plurality of representative patterns within each section by a controller provided in an apparatus for estimating uncertainty of an artificial neural network model according to an embodiment of the present disclosure.

As shown in FIG. 5, the controller 40 may determine a plurality of representative patterns within each section based on Equation 1. For example, the controller 40 may determine a first representative pattern 410, a second representative pattern 411, and a third representative pattern 412 as representative patterns of the first section.

Returning to FIG. 4, the controller 40 may perform normalization on a first feature pattern 420 received through the input device 20. In this case, the controller 40 may divide the first feature pattern 420 in L2 norm. For reference, norm means a scheme for calculating the magnitude of a vector, i.e., a scheme for measuring the distance (difference) between two points. As the number of dimensions (the number of features) of the norm is 2, the L2 norm represents the square root of the result of adding all the square values of differences between the same dimensions.

Thereafter, the controller 40 may divide the first feature pattern 420 into four sections. The controller 40 may also compare the first section of the first feature pattern 420 with representative patterns in the first section of the clustering model to determine the most similar representative pattern. In this case, the controller 40 may determine a representative pattern having the shortest dot product or Euclidean distance, LMS, or CC as the representative pattern most similar to the first section of the first feature pattern 420.

Thereafter, the controller 40 may compare the second section of the first feature pattern 420 with the representative patterns in the second section of the clustering model to determine the most similar representative pattern. In this case, the controller 40 may determine a representative pattern having the shortest dot product or Euclidean distance, LMS, or CC as the representative pattern most similar to the second section of the first feature pattern 420.

Thereafter, the controller 40 may compare the third section of the first feature pattern 420 with the representative patterns in the second section of the clustering model to determine the most similar representative pattern. In this case, the controller 40 may determine a representative pattern having the shortest dot product or Euclidean distance, LMS, or CC as the representative pattern most similar to the third section of the first feature pattern 420.

Thereafter, the controller 40 may compare the fourth section of the first feature pattern 420 with the representative patterns in the fourth section of the clustering model to determine the most similar representative pattern. In this case, the controller 40 may determine a representative pattern having the shortest dot product or Euclidean distance, LMS, or CC as the representative pattern most similar to the fourth section of the first feature pattern 420.

Through such a process, the first feature pattern 420 is most similar to the second representative pattern 411 in the first section of the clustering model, most similar to the first representative pattern in the second section of the clustering model, most similar to the second representative pattern in the third section of the clustering model, and most similar to the first representative pattern in the fourth section of the clustering model. Accordingly, the controller 40 may determine that the first feature pattern 420 is included in the 2-1-2-1 cluster. In this case, the integrated representative pattern of the 2-1-2-1 cluster may be expressed as a sequential combination of the second representative pattern of the first section, the first representative pattern of the second section, the second representative pattern of the third section, and the first representative pattern of the fourth section.

The controller 40 may perform normalization on a second feature pattern 430 received through the input device 20. The controller 40 may also divide the second feature pattern 430 into four sections. The controller 40 may also compare the first section of the second feature pattern 430 with the representative patterns in the first section of the clustering model to determine the most similar representative pattern. The controller 40 may also compare the second section of the second feature pattern 430 with the representative patterns in the second section of the clustering model to determine the most similar representative pattern. The controller 40 may also compare the third section of the second feature pattern 430 with the representative patterns in the third section of the clustering model to determine the most similar representative pattern. The controller 40 may also compare the fourth section of the second feature pattern 430 with the representative patterns in the fourth section of the clustering model to determine the most similar representative pattern.

Through such a process, it may be confirmed that the second feature pattern 430 is most similar to the third feature pattern 412 in the first section of the clustering model, most similar to the fourth feature pattern in the second section of the clustering model, most similar to the fifth feature pattern in the third section of the clustering model, and most similar to the fourth feature pattern in the fourth section of the clustering model. Accordingly, the controller 40 may determine that the second feature pattern 430 is included in the 3-4-5-4 cluster. In this case, the integrated representative pattern of the 3-4-5-4 cluster may be expressed as a sequential combination of the third representative pattern of the first section, the fourth representative pattern of the second section, the fifth representative pattern of the third section, and the fourth representative pattern of the fourth section.

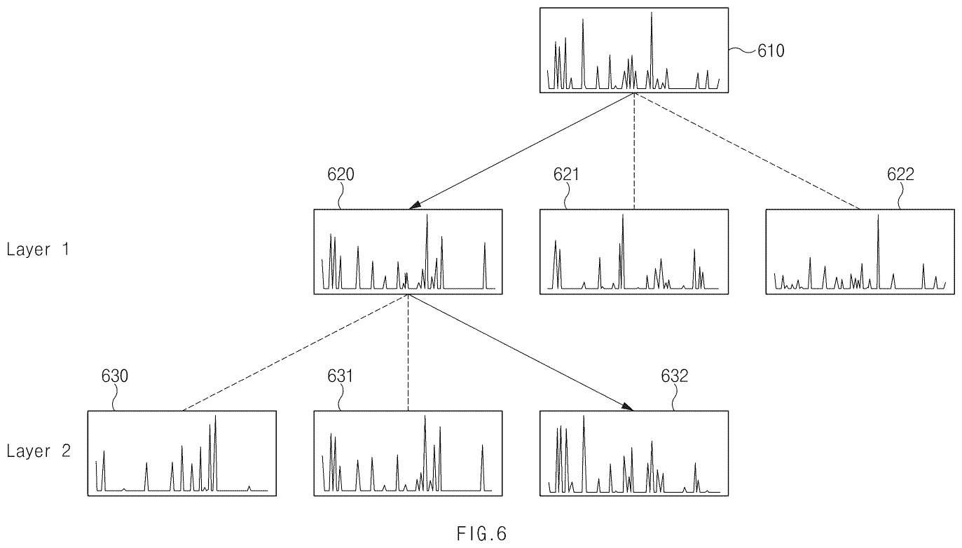

FIG. 6 is a diagram illustrating a second example of a process of determining a cluster corresponding to a feature pattern by a controller provided in an apparatus for estimating uncertainty of an artificial neural network model according to an embodiment of the present disclosure.

As shown in FIG. 6, as the second example, a tree-structured clustering model may be implemented with, for example, two layers, but is not limited thereto. In addition, three representative patterns may be included in the first layer, but the embodiment is not limited thereto. Such a tree-structured clustering model may classify clusters more precisely as the depth increases.

For example, a first layer in a tree-structured clustering model may include a first representative pattern 620, a second representative pattern 621, and a third representative pattern 622. A second layer may include a total of nine representative patterns including a fourth representative pattern 630, a fifth representative pattern 631, and a sixth representative pattern 632 as sub-patterns of the first representative pattern 620, three patterns (not shown) as sub-patterns of the second representative pattern 621, and three patterns (not shown) as sub-patterns of the third representative pattern 622. In this case, as shown in FIG. 4, the controller 40 may determine a plurality of representative patterns in each layer of the tree-structured clustering model based on Equation 1, similarly to a clustering model of a section division structure.

The controller 40 may perform normalization on a feature pattern 610 received through the input device 20. In this case, the controller 40 may divide the feature pattern 610 in L2 norm. For reference, the norm means a scheme for calculating the magnitude of a vector, i.e., a scheme for measuring the distance (difference) between two points. As the number of dimensions (the number of features) of the norm is 2, the L2 norm represents the square root of the result of adding all the square values of differences between the same dimensions.

Thereafter, the controller 40 may compare the feature pattern 610 with the representative patterns in the first layer of the clustering model to determine the most similar representative pattern. In this case, the controller 40 may determine a representative pattern having the shortest dot product or Euclidean distance, LMS, or CC as the representative pattern most similar to the feature pattern 610 (i.e., the representative pattern having the highest degree of similarity). The representative pattern determined in this manner is the first representative pattern 620.

Therefore, the controller 40 may perform a process of comparing sub-representative patterns of the first representative pattern 620. In other words, the controller 40 may compare the feature pattern 610 with the fourth representative pattern 630, the fifth representative pattern 631, and the sixth representative pattern 632 in the second layer of the clustering model to determine the most similar representative pattern. The sixth representative pattern 632 may be determined as the representative pattern in such a manner.

As a result, the controller 40 may determine that the feature pattern 610 is included in a cluster corresponding to the sixth representative pattern 632.

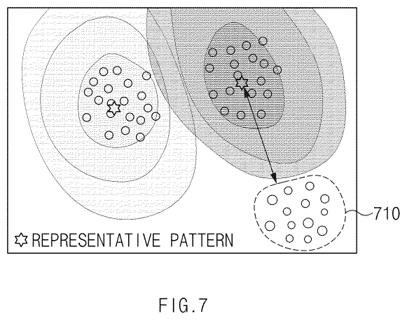

Hereinafter, a process of estimating an uncertainty value for a feature pattern by the controller 40 is described with reference to FIGS. 3 and 7.

FIG. 3 is a diagram illustrating uncertainty values for each cluster stored in storage provided in an apparatus for estimating uncertainty of an artificial neural network model according to an embodiment of the present disclosure.

As shown in FIG. 3, the controller 40 may determine an uncertainty value for a feature pattern based on a table in which uncertainty values for each cluster are recorded.

For example, the controller 40 may determine the uncertainty value of the feature pattern as 5.1 when the feature pattern is included in the first cluster. The controller 40 may also determine the uncertainty value of the feature pattern as 8.3 when the feature pattern is included in the second cluster. The controller 40 may also determine the uncertainty value of the feature pattern as 1.9 when the feature pattern is included in the third cluster. The controller 40 may also determine the uncertainty value of the feature pattern as 9.5 when the feature pattern is included in the fourth cluster. The controller 40 may also determine the uncertainty value of the feature pattern as 3.7 when the feature pattern is included in the fifth cluster. The controller 40 may also determine the uncertainty value of the feature pattern as 7.2 when the feature pattern is included in the sixth cluster.

FIG. 7 is a diagram illustrating a process of determining an uncertainty value of a feature pattern by a controller provided in an apparatus for estimating uncertainty of an artificial neural network model according to an embodiment of the present disclosure.

As shown in FIG. 7, the controller 40 may calculate a distance between a feature pattern 710 and a representative pattern of a cluster and may determine a calculated distance as an uncertainty value of the feature pattern 710. In this case, the distance between the feature pattern 710 and the representative pattern of the cluster means a dot product, Euclidean distance, LMS, or CC.

When the calculated distance exceeds a threshold distance, the controller 40 may recognize the feature pattern 710 as an out of distribution (OOD) pattern and discard the feature pattern 710. In this case, the OOD pattern, which is data that is not included in the distribution of learning data, may degrade the learning performance of a clustering model.

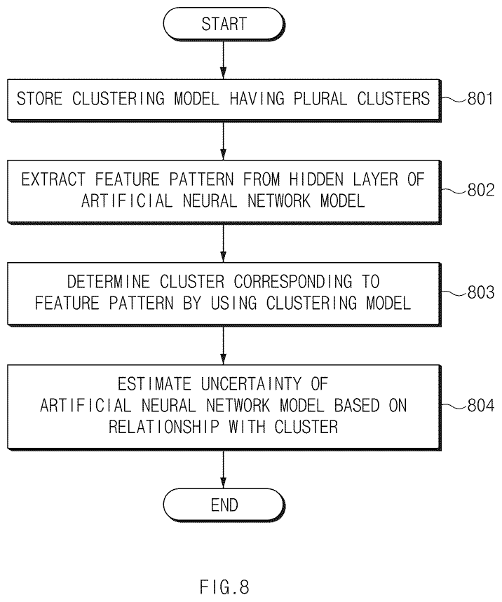

FIG. 8 is a flowchart illustrating a method of estimating uncertainty of an artificial neural network model according to an embodiment of the present disclosure.

First, the storage 10 stores a clustering model having a plurality of clusters in 801.

Thereafter, in 802, the controller 40 extracts a feature pattern from a hidden layer of an artificial neural network model.

Thereafter, in 803, the controller 40 determines a cluster corresponding to the feature pattern by using the clustering model. In this case, the controller 40 may determine a cluster corresponding to the feature pattern based on a clustering model of a section division structure or may determine the cluster corresponding to the feature pattern based on a tree-structured clustering model.

Thereafter, in 804, the controller 40 estimates the uncertainty of the artificial neural network model based on the relationship with the cluster. In this case, the controller 40 may determine the uncertainty value preset for the cluster as the uncertainty value for inference of the artificial neural network model. Alternatively, the controller 40 may determine the distance between the representative pattern of the cluster and the feature pattern as the uncertainty value for inference of the artificial neural network model.

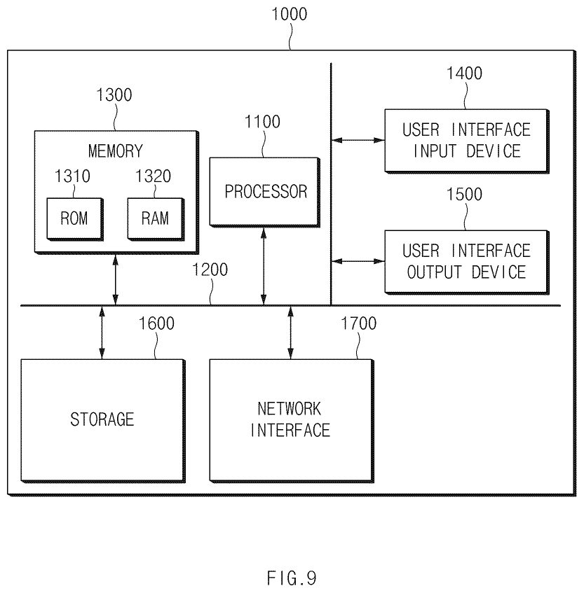

FIG. 9 is a block diagram illustrating a computing system for executing a method of estimating uncertainty of an artificial neural network model according to an embodiment of the present disclosure.

Referring to FIG. 9, a method of estimating uncertainty of an artificial neural network model according to an embodiment of the present disclosure described above may be implemented through a computing system. A computing system 1000 may include at least one processor 1100, a memory 1300, a user interface input device 1400, a user interface output device 1500, storage 1600, and a network interface 1700 connected through a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (i.e., the memory 1300 and/or the storage 1600), such as a RAM, a flash memory, a ROM, an EPROM, an EEPROM, a register, a hard disk, solid state drive (SSD), a detachable disk, or a CD-ROM. The storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

According to the embodiments of the present disclosure, a clustering model having a preset number of clusters for a plurality of feature patterns may be provided to extract an output of a hidden layer in an artificial neural network model as a feature pattern. The clustering model may also determine a cluster corresponding to the feature pattern by using the clustering model. The clustering model may also estimate the uncertainty of the artificial neural network model based on a relationship with the cluster, so that it is possible to significantly reduce the time complexity and space complexity required for estimating the uncertainty of the artificial neural network model and improve the accuracy of estimation.

In addition, according to the embodiments of the present disclosure, a clustering model having a preset number of clusters for a plurality of feature patterns may be provided to extract an output of a hidden layer in the artificial neural network model as a feature pattern. The clustering model may determine a cluster corresponding to the feature pattern by using the clustering model. The clustering model may estimate uncertainty of the artificial neural network model based on a relationship with the cluster, so that it is possible to interpret the estimation result of the uncertainty, to improve the reliability of the fail-safe function, and to improve the performance of the artificial neural network model.

Although embodiments of the present disclosure have been described for illustrative purposes, those having ordinary skill in the art will appreciate that various modifications, additions, and substitutions are possible, without departing from the scope and spirit of the disclosure. Therefore, the embodiments disclosed in the present disclosure are provided for the sake of descriptions and are not intended to limit the technical concepts of the present disclosure. It should be understood that such embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus for estimating uncertainty of an artificial neural network model, the apparatus comprising:
a storage configured to store a clustering model having a plurality of clusters; and
a controller configured to:
extract a feature pattern from a hidden layer of the artificial neural network model;
determine a cluster corresponding to the feature pattern by using the clustering model; and
estimate the uncertainty of the artificial neural network model based on a relationship with the cluster.

2. The apparatus of claim 1, wherein the controller is configured to normalize the feature pattern.

3. The apparatus of claim 1, wherein the clustering model includes a plurality of representative patterns for each section as a clustering model of a section division structure.

4. The apparatus of claim 3, wherein the controller is configured to:
divide the feature pattern into a plurality of sections;
compare a first section of the feature pattern with representative patterns in a first section of the clustering model to determine a first representative pattern that is most similar;
compare a second section of the feature pattern with representative patterns in a second section of the clustering model to determine a second representative pattern that is most similar; and
determine a cluster corresponding to an integrated representative pattern formed of sequential combinations of the first representative pattern and the second representative pattern as a cluster of the feature pattern.

5. The apparatus of claim 4, wherein the controller is configured to determine a representative pattern that is most similar to the feature pattern for each of the divided sections.

6. The apparatus of claim 4, wherein the controller is configured to select a representative pattern having a shortest dot product or Euclidean distance, least mean square (LMS), or cross correlation (CC) with respect to the feature pattern for each divided section.

7. The apparatus of claim 4, wherein the storage is configured to further store a table in which uncertainty values for each of the plurality of clusters are recorded.

8. The apparatus of claim 7, wherein the controller is configured to determine an uncertainty value corresponding to the cluster based on the table.

9. The apparatus of claim 4, wherein the controller is configured to determine a distance between the integrated representative pattern of the cluster and the feature pattern as an uncertainty value of the feature pattern.

10. The apparatus of claim 9, wherein the controller is configured to determine the feature pattern as an out of distribution (OOD) pattern when a distance between the integrated representative pattern of the cluster and the feature pattern exceeds a threshold distance.

11. The apparatus of claim 1, wherein the clustering model includes a plurality of representative patterns for each layer as a tree-structured clustering model.

12. The apparatus of claim 11, wherein the controller is configured to:
determine a first representative pattern that is most similar to the feature pattern among representative patterns of a first layer in the tree-structured clustering model;
determine a second representative pattern that is most similar to the feature pattern among sub-representative patterns of the first representative pattern; and
determine a cluster corresponding to the second representative pattern as a cluster of the feature pattern.

13. The apparatus of claim 12, wherein the controller is configured to determine a representative pattern that is most similar to the feature pattern for each layer.

14. The apparatus of claim 12, wherein the controller is configured to select a representative pattern having a shortest dot product or Euclidean distance, least mean square (LMS), or cross correlation (CC) with respect to the feature pattern for each layer.

15. The apparatus of claim 12, wherein the storage is configured to further store a table in which uncertainty values for each of the plurality of clusters are recorded.

16. The apparatus of claim 15, wherein the controller is configured to determine an uncertainty value corresponding to the cluster based on the table.

17. The apparatus of claim 12, wherein the controller is configured to determine a distance between the second representative pattern of the cluster and the feature pattern as an uncertainty value of the feature pattern.

18. The apparatus of claim 17, wherein the controller is configured to determine the feature pattern as an out of distribution (OOD) pattern when a distance between the second representative pattern of the cluster and the feature pattern exceeds a threshold distance.

19. A method of estimating uncertainty of an artificial neural network model, the method comprising:
storing, by storage, a clustering model having a plurality of clusters;
extracting, by a controller, a feature pattern from a hidden layer of the artificial neural network model;
determining, by the controller, a cluster corresponding to the feature pattern by using the clustering model; and
estimating, by the controller, uncertainty of the artificial neural network model based on a relationship with the cluster.

20. The method of claim 19, wherein the clustering model includes a plurality of representative patterns for each section as a clustering model of a section division structure, or
wherein the clustering model includes a plurality of representative patterns for each layer as a tree-structured clustering model.
